(19) United States
(12) Patent Application Publication
(10) Pub. No.: US 2005/0093513 A1
(43) Pub. Date: May 5, 2005

(54) Electronic device having multiple current outputs

(76) Inventors: Kathryn W. Herbener, Fort Collins, CO (US); Samuel M. Bobb, Fort Collins, CO (US); Roger A. Pearson, Fort Collins, CO (US); Charles H. Rock, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/701,286

(22) Filed: Nov. 3, 2003

(51) Int. Cl. H02J 7/00

(52) U.S. Cl. 320/116

(57) ABSTRACT

Embodiments of an electronic device and method are disclosed herein. One embodiment of the electronic device comprises a power supply and a processor circuit. The power supply comprises a supply input and a supply output, the supply output suppling a first power when the supply input is at a first voltage and a second power when the supply input is at a second voltage. The processor circuit comprises a processor circuit power input and a processor circuit output. The processor circuit power input is operatively connectable to the supply output and the processor circuit output is operatively connectable to the supply input. The first voltage is present at the supply input when the processor circuit output is operatively connected to the supply input.

### BACKGROUND

Many computer systems have several processors, storage devices, peripherals, and memory associated therewith. Many of these devices are modular, which enables them to be readily exchanged from a computer system. For example, the computer system may have a plurality of processor circuits that connect to a motherboard or the like. The processing circuits may have a plurality of processing units, i.e., CPUs, connected thereto. The motherboard supplies power and data connections to the processor circuit and, thus, the processing units.

Many of the processing units plug into the processing circuit, which enables them to be readily exchanged. Thus, should a processing unit need to be exchanged, it may simply be unplugged from the processing circuit and a different processing unit may be plugged into the processing circuit. It should be noted that the processing circuit may operate with a processing unit removed therefrom, leaving exposed conductors in its place. In many applications, the processor circuit as a whole may be readily exchanged by disconnecting or unplugging it from the mother board and connecting or plugging a replacement processor circuit into the motherboard.

The devices associated with the computer system typically operate at a low voltage, but draw high power by drawing high current. For example, the devices may operate from a twelve volt power supply and they may need to draw twenty amperes when all the devices are active. In order to power these devices, the computer system has a power supply capable of supplying high current.

If this high current power supply becomes inadvertently shorted, safety issues arise. For example, excessive heat may be generated within an object that shorts the power supply. The excessive heat may ignite the object or other objects in its vicinity causing injury to the computer system and persons in its proximity. Another problem may occur if the power supply is shorted to a low resistance electronic device. The low resistance electronic device will draw high current and may be destroyed or may even ignite.

### SUMMARY

Embodiments of an electronic device and method are disclosed herein. One embodiment of the electronic device comprises a power supply and a processor circuit. The power supply comprises a supply input and a supply output, the supply output suppling a first power when the supply input is at a first voltage and a second power when the supply input is at a second voltage. The processor circuit comprises a processor circuit power input and a processor circuit output. The processor circuit power input is operatively connectable to the supply output and the processor circuit output is operatively connectable to the supply input. The first voltage is present at the supply input when the processor circuit output is operatively connected to the supply input.

### BRIEF DESCRIPTION OF THE DRAWINGS FIG. 1 is a schematic illustration of an electronic device according to an embodiment of the present invention.

FIG. 2 is a schematic illustration of an embodiment of the power supply of FIG. 1.

FIG. 3 is a schematic illustration of an embodiment of the monitoring circuit of FIG. 1.

FIG. 4 is a schematic illustration of another embodiment of the electronic device of FIG. 1.

FIG. 5 is a schematic illustration of a further embodiment of the electronic device of FIG. 1.

### DETAILED DESCRIPTION

A non-limiting embodiment of a schematic illustration of an electronic device 100 is shown in FIG. 1. The electronic device 100 is described herein as being a computer system. However, it is to be understood that the electronic device 100 may be any one of a number of electronic devices.

The electronic device 100 described herein has, among other components, a processor circuit 110, a monitoring device 112, and a power supply 114. The components are operatively or otherwise electrically connected together as described in greater detail below. In the embodiment of the electronic device 100 of FIG. 1, the components are shown as being individual components. It is to be understood, however, that some or all the components may be located on a single printed circuit board or the like. The processor circuit 110 may have, among other components, a first processing unit 118 (sometimes referred to herein as processing unit one 118), a socket 119, a second processing unit 120 (sometimes referred to herein as processing unit two 120), a socket 121, a connector 122, and a connector 124. In the embodiment of the electronic device 100 described herein, processing unit one 118 is plugged into the socket 119 and processing unit two 120 is plugged into the socket 121. Accordingly, processing unit one 118 and processing unit two 120 are connectable to the processor circuit 110. The connector 122 and the conductors associated therewith are sometimes referred to as the processor circuit output. The connector 124 and the conductors associated therewith serve to receive power for the processor circuit 110. Accordingly, the connector 124 and the conductors associated therewith are sometimes referred to as the processor circuit power input.

Processing unit one 118, as illustrated herein, has three lines or conductors associated therewith. The terms line and conductor as used herein include any data transfer device or means, including electrical and optical data transmission devices. It should be noted that processing unit one 118 may have other lines associated therewith that are not illustrated herein. A power input 130 provides power to processing unit one 118. An active line 132 provides a signal indicating the status of processing unit one 118. For example, if the voltage output on the active line 132 is high (logic level one), processing unit one 118 may be in an active mode. If the voltage output on the active line 132 is low (logic level zero), processing unit one 118 may be in an inactive or sleep mode. A socket-occupied line 134 outputs a voltage indicating whether processing unit one 118 is electrically connected to the processor circuit 110. For example, the socket-occupied line 134 may be grounded when processing unit one 118 is electrically connected to the processor circuit 110. When processing unit one 118 is not electrically connected to the processing circuit 110, the socket-occupied line 134 may float high.

Processing unit two 120, as illustrated herein, has three conductors or lines associated therewith that are similar to the lines associated with processing unit one 118. A power input 138 may provide power to processing unit 120 in a manner similar to the power input 130. An active line 140 may provide an indication as to the states, active or inactive, of processing unit two 120 in a manner similar to the active line 132. A socket-occupied line 142 may provide an indication as to whether processing unit two 120 is electrically connected to the processor circuit 110 in a similar manner as the socket-occupied line 134.

A plurality of conductors or lines 146 operatively or otherwise electrically connect the processor circuit 110 to the monitoring device 112. Likewise, a line 148 operatively or otherwise electrically connects the processor circuit 110 to the power supply 114. In addition, a line 149 may operatively connect the monitoring device 112 to the power supply 114. The lines 146, 148 may, as a non-limiting example, be located on or part of a back plane or other mechanism used to connect electronic components within the electronic device 100. In one example, the lines 146 and 148 are cables.

The monitoring device 112 serves to monitor the status of the processor circuit 110 and to determine the amount of current that may be supplied to the processor circuit 110. The non-limiting embodiment of the monitoring device 112 described herein has an AND gate 152, a first inverter 154, and a second inverter 156. In addition, the embodiment of the monitoring device 112 described herein has a first connector 158, a resistor R1, and a resistor R2. It should be noted that the electrical components and their arrangement within the monitoring device 112 show a non-limiting embodiment of the monitoring device 112 and that different components used in different configurations may be used within the monitoring device 112.

The monitoring device 112 may be connectable to both the processor circuit 110 and the power supply 114 by way of the connector 158. For example, the monitoring device 112 may electrically connect to the aforementioned back plane or other mechanism by way of the connector 158. It should be noted that in one embodiment of the electronic device 100, the monitoring device 112 resides on the processor circuit 110.

The socket-occupied line 134 of processing unit one 118 is connected to the input of the first inverter 154. The socket-occupied line 142 of processing unit two 120 is connected to the input of the second inverter 156. As described above, in the non-limiting embodiment of the electronic device 100 described herein, the socket-occupied line 134 and the socket-occupied line 142 are connected to ground when processing unit one 118 and processing unit two 120, respectively, are connected to the processor circuit 110. Accordingly, when processing unit one 118 is connected to the processor circuit 110, the output of the first inverter 154 is high. Likewise, when processing unit two 120 is connected to the processor circuit 110, the output of the second inverter 156 is high. The resistor R1 and the resistor R2 serve as pull-up resistors to assure that the socket-occupied line 134 and the socket-occupied line 142 are pulled high when processing unit one 118 and processing unit two 120, respectively, are not connected to the processor circuit 110. Accordingly, when processing unit one 118 is not connected to the processor circuit 110, the output of the first inverter 154 is low. Likewise, when processing unit two 120 is not connected to the processor circuit 110, the output of the second inverter 156 is low.

The outputs of both the first inverter 154 and the second inverter 156 along with the active line 132 and the active line 140 are connected to the AND gate 152. An output line 160 of the AND gate 152 is low unless both the active line 132 and the active line 140 are high and both the socket-occupied line 134 and the socket-occupied line 142 are low. It should be noted that the logic circuit of FIG. 1 is only an example of many different circuit or logic configurations that may achieve the above-described results.

The power supply 114 described herein has a power mode input and a power output (sometimes referred to as a supply input and a supply output). It should be noted that the power supply 114 may have many other inputs and outputs that are not shown or described herein. The power mode input is operatively connected to the output of the AND gate 152 via the line 149 and serves to select the amount of current that may be supplied by way of the power output. The power output is operatively connected to the connector 124 of the processor circuit 110 via the line 148. In the non-limiting embodiment described herein, a low voltage at the power mode input causes the current that is able to be supplied at the power output to be low. Likewise, a high voltage at the power mode input causes the current that is able to be supplied at the power output to be high.

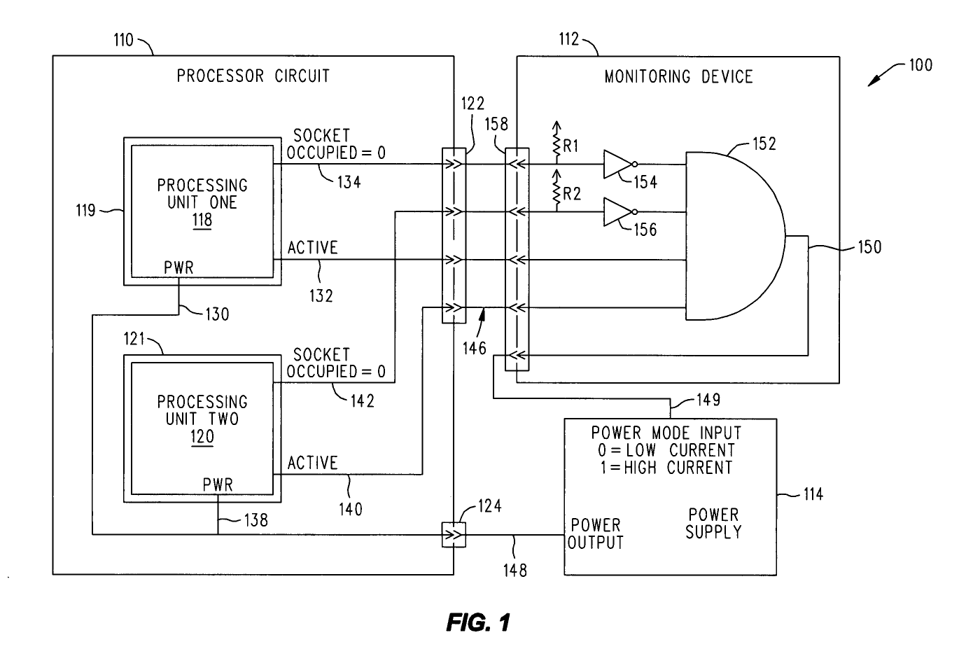

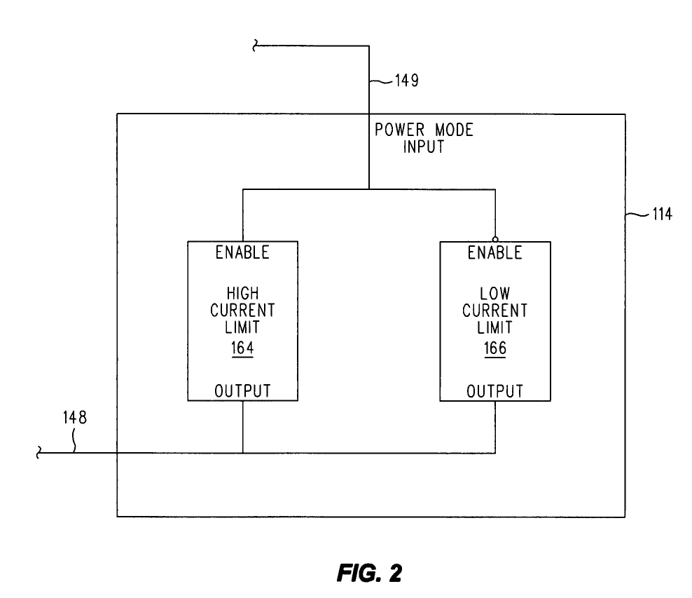

A non-limiting embodiment of the power supply 114 is shown in FIG. 2. In this embodiment of the power supply 114, the power supply 114 has a high current limit 164 and a low current limit 166. The high current limit 164 is enabled when the power mode input is high and the low current limit 166 is enabled when the power mode input is low. Accordingly, the power supply 114 is either in a high current mode or a low current mode. The high current limit 164 may, solely as an example, enable the power supply 114 to output twenty amperes and the low current limit 166 may enable the power supply 114 to output ten amperes.

The processor circuit 110 draws high current from the power supply 114 to operate both processing unit one 118 and processing unit two 120. The processor circuit 110 and, thus, the electronic device 100 as a whole, draw less current when either processing unit one 118 or processing unit two 120 is not operating. This reduced current reduces the possibility of an object causing a short circuit within the processor circuit 110. For example, access to either the socket 119 or the socket 121 may occur when processing unit one 118 or processing unit two 120, respectively, are not located therein. Accordingly, an object may short between a conductor on either the socket 119 or the socket 121 and another conductor located within the electronic device 100. The electronic device 100 described herein reduces the adverse affect of a short by reducing the current limit of the power supply 114 when either processing unit one 118 or processing unit two 120 is not connected to the processor circuit 110 or when they are inactive. In addition to reducing the effects of a short circuit, the reduced current limit also lessens the possibility of an operator being shocked by contacting an empty socket 119, 121. It should be noted that a short circuit may be created or an operator being shocked by contact with other components on the processor circuit 110 and that the concepts described herein will reduce these risks.

As briefly described above, the electronic device 100 will only enable the power supply 114 to output high current when both processing unit one 118 and processing unit two 120 are electrically connected to the processor circuit 110 and both processing units are active. Otherwise, low current will be supplied from the power supply 114. If both processing unit one 118 and processing unit two 120 are electrically connected to the processor circuit 110, both the socket-occupied line 134 and the socket-occupied line 142 are grounded. The low voltages on the socket-occupied line 134 and the socket-occupied line 142 cause both the first inverter 154 and the second inverter 156 to output high voltages to the AND gate 152. If both processing unit one 118 and processing unit two 120 are active, then high voltages are present on both the active line 132 and active line 140. In this situation, all the inputs to the AND gate 152 are high and, thus, the output lines 149 and 150 are high in addition to the power mode input of the power supply 114. The high voltage at the power mode input of the power supply 114 enables the power supply 114 to output high current via the power output. In one embodiment of the power supply 114, the current limit of the power supply 114 is increased to a preselected amount.

When any of the above conditions are not met, the low current limit 166 of the power supply 114 will be enabled causing the current supplied by the power supply 114 to be reduced. For example, if the processor circuit 110 becomes disconnected or otherwise is not operatively connected to the monitoring device, the output of the AND gate 152 will be low and the high current limit 164 will be disabled. When the high current limit 164 is disabled, the low current limit 166 is enabled, which reduces the current that is able to be supplied by the power supply 114. In another example, if either processing unit one 118 or processing unit two 120 becomes disconnected or is otherwise not operatively connected to the processor circuit 110, the high current limit 164 will be disabled and the low current limit 166 will be enabled. The same will occur if either processing unit one 118 or processing unit two 120 become inactive.

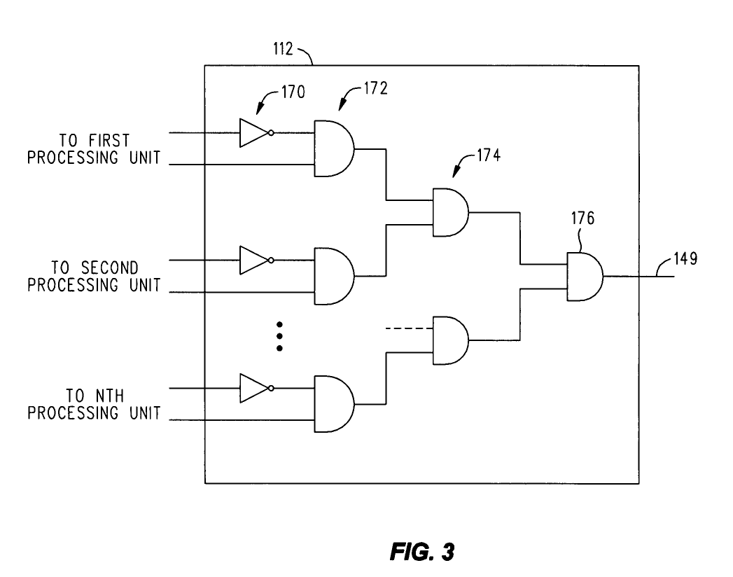

Another embodiment of the monitoring device 112 is shown in FIG. 3. The monitoring device 112 of FIG. 3 is adapted to monitor the status of several processing units. More specifically, the monitoring device 112 is adapted to monitor the status of N processing units. A plurality of N inverters 170 are operatively connected to socket-occupied lines of N sockets in a manner similar to that shown and described with reference to FIG. 1. The monitoring device 112 of FIG. 3 has N two-input first AND gates 172. One input of each of the first AND gates 172 is connected to the output of one of the inverters 170. The other input of each of the first AND gates 172 is connected to the active line of each of the processors. The outputs of the first AND gates 172 are connected to inputs of second AND gates 174. The outputs of the second AND gates 174 are connected to the inputs of a output AND gate 176, wherein the output of the output AND gate 176 is operatively connected to the line 149. It should be noted that more or less AND gates than are illustrated in FIG. 3 may be used to achieve the same purpose. The monitoring device 112 of FIG. 3 is configured so that all the processing units are operatively connected to the processing circuit 110, FIG. 1, and be active in order for the line 149 to be high. A high voltage on line 149 will cause the power supply 114 to use the high current limit. If any of the above-described conditions are not met, the low current limit of the power supply 114 will be enabled.

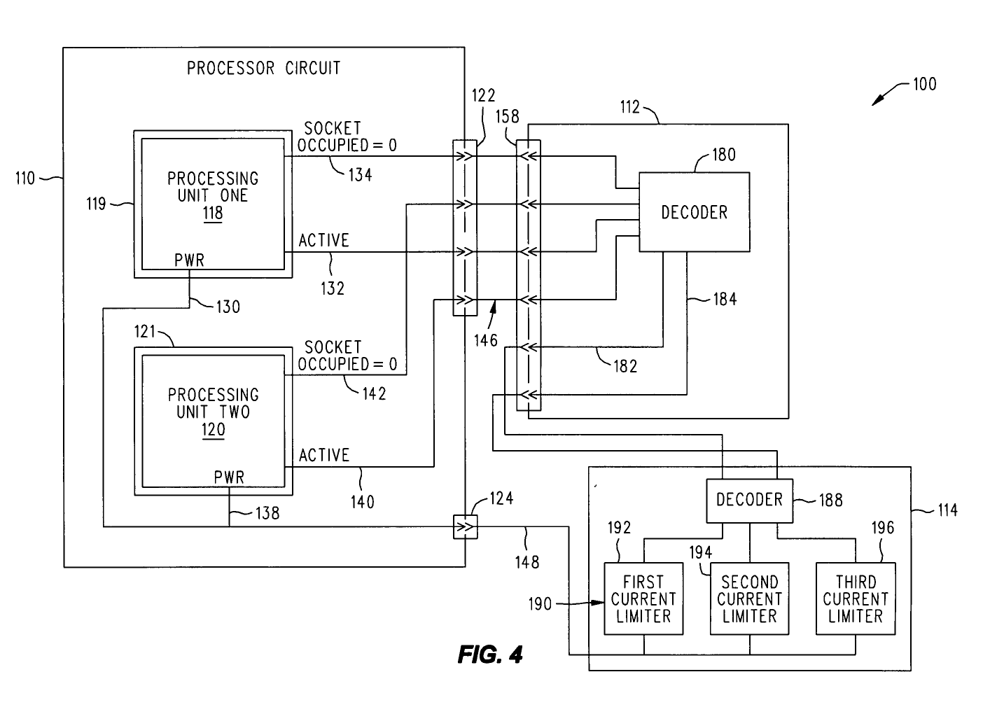

Another embodiment of the electronic device 100 is shown in FIG. 4. In this embodiment, a decoder 180 is located within the monitoring device 112 to determine the number of processing units that are both connected to the processor circuit 110 and active. The decoder 180 outputs binary data via two lines 182 and 184 that is representative of the number of processing units that are connected to the processor circuit 110 and that are active. For example, if both processing unit 118 and processing unit 120 are either disconnected from the processor circuit 110 or are inactive, lines 182 and 184 may be low representing a binary zero. If one, but not both, processing unit one 118 or processing unit two 120 are connected to the processor circuit 110 and active, either line 182 or line 184 may be high representing a binary one. If both processing unit 118 and processing unit 120 are connected to the processor circuit 110 and both are active, both lines 182 and 184 may be high representing a binary four. It should be noted that other binary number combinations may be used to represent the number of processing units that are connected to the processor circuit 110 and active.

Both lines 182 and 184 are connected to the power mode input of the power supply 114, which in turn connects the lines 182 and 184 to a decoder 188. The decoder 188 is operatively connected to a plurality of current limiters 190, referred to as current limiter 192, current limiter 194, and current limiter 196. When a binary zero is present on the lines 182 and 184, the decoder 188 enables current limiter 192 and disables current limiters 194 and 196. The first current limiter 192 may, as a non-limiting example, limit the current able to be output by the power supply 114 to ten amperes. When a binary one is present on the lines 182 and 184, the decoder 188 enables the second current limiter 194 and disables the first current limiter 192 and the third current limiter 196. The second current limiter 194 may, as a non-limiting example, limit the current that is able to be output by the power supply 114 to fifteen amperes. If a binary four is present on the lines 182 and 184, the decoder will enable the third current limiter 196 and disable both the first current limiter 192 and the second current limiter 194. The third current limiter 196 may, as a non-limiting example, limit the current that is able to be output by the power supply 114 to twenty amperes.

The embodiment of the electronic device 100 of FIG. 4 is able to provide as many current levels or current limitations as desired, depending on the design choice processor circuit 110. The embodiment of FIG. 4 may be expanded to any number of current limitations to provide for any number of processing units connected to the processor circuit 110. It should also be noted that the embodiment of FIG. 4 may instead be adapted to output serial binary data or other data configurations, e.g., as different digital numbers, from the monitoring device 112 rather than parallel binary data. Accordingly, first, second, and third levels of current are able to be supplied to the processor circuit 110.

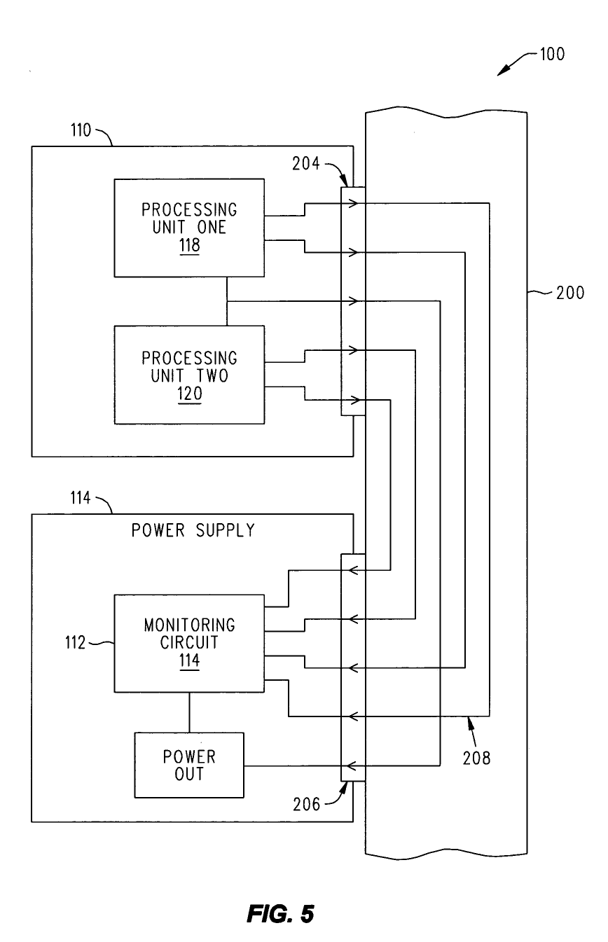

Another embodiment of the electronic device 100 is shown in FIG. 5. In the embodiment of FIG. 5, the processor circuit 110 and the monitoring device 112 are connected or connectable to a motherboard or backplane 200. A connector 204 or connecting means connects the processor circuit 110 to the backplane 200. Likewise, a connector 206 or connecting means connects the monitoring device 112 to the backplane 200. The backplane 200 has a plurality of lines 208 connected between the connector 204 and the connector 206. Should the processor circuit 110 become disconnected from the backplane 200, the power supply 114 will receive signals indicating that the processing units are not connected to the processor circuit 110. The monitoring device 112 will then reduce the amount of current that is able to be supplied to the backplane 200 and, thus, the processor circuit 110. Accordingly, should an object cause a short circuit between the connector 204 and a conductor within the electronic device 100, the effects will be minimized.

Referring again to FIG. 1, it should be noted that the electronic device 100 may reduce current upon detecting that at least one of processing unit one 118 and processing unit two 120 is not connected to the processor circuit 110. In this embodiment, high current may be supplied to the processor circuit 110 if both processing unit one 118 and processing unit two 120 are connected to the processor circuit 110, regardless of whether they are active. Application of this embodiment may employ a single two-input AND gate within the monitoring device 112 instead of a four-input AND gate and the inverters 154, 156.

In this embodiment, if processing unit one 118 is not connected to the socket 119, the voltage on the socket-occupied line 134 will be high. This high voltage causes the output of the inverter 154 to be low, which also causes the output of the AND gate to be low. As set forth above, low current limiting is then employed. The same occurs if processing unit two 120 is not located in the socket 121. The voltage on the socket-occupied line 142 will be high, which will cause the output of the inverter 156 to be low. In turn, the output of the AND gate will be low, which causes low current limiting to be employed.

1. An electronic device comprising:
a power supply comprising a supply input and a supply output, said supply output supplying a first level of power when said supply input is at a first voltage, and said supply output supplying a second level of power when said supply input is at a second voltage;
a processor circuit comprising a processor circuit power input and a processor circuit output, said processor circuit power input operatively connectable to said supply output, said processor circuit output operatively connectable to said supply input,
said first voltage being present at said supply input when said processor circuit output is operatively connected to said supply input.

2. The electronic device of claim 1, wherein said second voltage is present at said supply input when said processor circuit output is not operatively connected to said supply input.

3. The electronic device of claim 1, and further comprising at least one processing unit, said at least one processing unit comprising at least one line that provides an indication as to whether said processing unit is electrically connected to said processor circuit, said at least one line operatively connectable to said processor circuit output.

4. The electronic device of claim 1, and further comprising at least one processing unit, said at least one processing unit comprising at least one line that provides an indication as to whether said processing unit is active, said at least one line operatively connectable to said processor circuit output.

5. The electronic device of claim 1, and further comprising a monitoring circuit, said monitoring circuit output providing said first voltage when at least one line provides an indication that at said least one processing unit is electrically connected to said processor circuit and said at least one processing unit is active.

6. The electronic device of claim 1, wherein a first current is able to be supplied by said power supply when said supply input is at a first voltage, and wherein a second current is able to be supplied by said power supply when said supply input is at a second voltage.

7. An electronic device comprising:
a processor circuit;
a first socket, wherein a first processing unit is connectable to said first socket;
a power supply connectable to said first socket, said power supply able to supply a first current level to said first socket when said first processing unit is not connected to said first socket, and a second current level when said first processing unit is connected to said first socket.

8. The electronic device of claim 7, and further comprising at least one second socket, wherein at least one second processing unit is connectable to said at least one second socket, and wherein said first current level is supplied by said power supply to said at least one second socket when said at least one second processing unit is not connected to said at least one second socket.

9. The electronic device of claim 8, wherein said second current level is supplied to said first socket and said at least one second socket if said first processor is connected to said first socket or if said at least one second processor is connected to said at least one second socket.

10. The electronic device of claim 8, wherein a third current level is supplied to said first socket and said at least one second socket if said first processor is connected to said first socket and said at least one second processor is connected to said at least one second socket.

11. The electronic device of claim 7, wherein said first current is supplied by said power supply when said first processing unit is not active.

12. The electronic device of claim 8, wherein said first current is supplied by said power supply when said at least one second processing unit is not active.

13. The electronic device of claim 9, wherein said second current level is supplied by said power supply when said first processing unit is connected to said first socket and said at least one second processing unit is connected to said at least one second socket and said first processing unit is active and said at least one second processing unit is active.

14. The electronic device of claim 8, wherein a third current is supplied by said power supply when said first processing unit is active and said at least one second processing unit is active.

15. The electronic device of claim 7, wherein said first current level is supplied by said power supply to said first socket when said first processing unit is not active; and said second current level is supplied by said power supply to said first socket when said first processing unit is connected to said first socket and said first processing unit is active.

16. A method for providing power to a processor circuit, said processor circuit comprising at least one location for a processing unit to connect thereto, said method comprising:
providing a first level of power to said processor circuit if a processing unit is connected to said at least one location; and
providing a second level of power to said processor circuit if no processing unit is connected to said at least one location;
said first level of power being greater than said second level of power.

17. The method of claim 16, wherein said providing a first level of power further comprises providing a first level of power to said processor circuit if said at least one processing unit is active.

18. The method of claim 16, wherein said providing a second level of power further comprises providing a second level of power to said processor circuit if said at least one processing unit is not active.

19. The method of claim 16, wherein said processor circuit is operatively connectable to a second circuit and wherein said providing a first level of power to said processor circuit further comprises providing a first level of power to said processor circuit if said processor circuit is connected to said second circuit.

20. The method of claim 16, wherein said processor circuit is operatively connectable to a second circuit and wherein said providing a second level of power further comprises providing a second level of power to said processor circuit if a processor circuit is not connected to said second circuit.

21. A method for providing power to a processor circuit from a power supply, said processor circuit comprising at least two locations for processing units to connect thereto, said method comprising:
providing a first level of power to said processor circuit if a first processing unit is connected to said a first location and a second processing unit is connected to a second location; and
providing a second level of power to said processor circuit if no processing units are located in either of said at least two locations;
said first level of power being greater than said second level of power.

22. The method of claim 21, wherein said providing a first level of power further comprises providing a first level of power to said processor circuit if said first processing unit is active and said second processing unit is active.

23. The method of claim 21, wherein said providing a second level of power further comprises providing a second level of power to said processor circuit if said first processing unit or said second processing unit is inactive.

24. The method of claim 21 and further comprising providing a third level of power to said processor circuit if said first processing unit is connected to said first location and no processing unit is connected to said second location.

25. An electronic device comprising:
a circuit means; and
supply means for supplying power to said circuit means, said supply means able to supply a first level of power to said circuit means when a processing means is connected to said circuit means, said supply means able to supply a second level of power to said circuit means when said processing means is not connected to said circuit means, said first level of power being greater than said second level of power.

26. The electronic device of claim 25, further comprising a monitoring means monitors for monitoring whether a processing means connected to said circuit means is active.
